(19) United States
(12) Patent Application Publication
(10) Pub. No.: US 2024/0360527 A1
(43) Pub. Date: Oct. 31, 2024

(54) ALUMINUM ALLOY DEOXIDIZER WITH CARBON COMPOUNDS

(71) Applicant: HF investment Co., LTD., Taichung City (TW)

(72) Inventor: CHIEN-HAO LEE, Taichung City (TW)

(21) Appl. No.: 18/644,887

(22) Filed: Apr. 24, 2024

(30) Foreign Application Priority Data
Apr. 28, 2023 (TW) 112115934

(51) Int. Cl. C21C 7/06; C21C 7/00

(52) U.S. Cl. CPC C21C 7/06; C21C 7/0006

(57) ABSTRACT

The present invention provides an aluminum alloy deoxidizer with carbon compounds, composed of multiple aluminum pellets. The main component of the aluminum pellets is elemental aluminum, and the aluminum pellets includes a weight percentage of 0.1 to 8 of carbon or organic compounds.

### FIELD OF INVENTION

The present invention relates to aluminum alloy deoxidizers, more particularly, to aluminum alloy deoxidizers with carbon compounds.

### BACKGROUND OF THE INVENTION

Circular economy has become prominent in modern society. Differing from traditional linear economic model, which involves resource extraction, production, consumption, and eventual disposal, circular economy model, based on resource recovery and reuse, aims to minimize resource consumption and waste to the greatest extent possible. This model encourages the circulation of resources and seeks to maximize resource value through means such as resource recovery, regeneration, and reuse, thereby achieving a sustainable economic development model.

Metal and related manufacturing industries are significant consumers of resources and sources of environmental pollution, making the implementation of a circular economy imperative for this sector. Many stakeholders in these industries have long practiced metal recycling, as recycling metals can save significant amounts of raw materials and energy, reduce carbon emissions, and enable the reuse of recycled metals in manufacturing new products. However, the current recycling process in the aluminum industry involves melting and refining recycled aluminum, which incurs high energy consumption, frequent operations, and high operational costs. Additionally, the oxidation caused by heating leads to significant loss of aluminum metal, and the recycling of scrap aluminum generates toxic fumes, dust, and slag.

Furthermore, the current recycling process in the aluminum industry involves collecting recycled aluminum materials such as aluminum cans, aluminum foil packaging, or aluminum scraps generated from machining and cutting processes. However, these recycled aluminum materials often contain a certain amount of organic matter due to their usage requirements and characteristics before recycling. For example, aluminum cans may have resin coatings on their internal surfaces and printing coatings on their exteriors, while aluminum scraps may contain cutting fluids. During the existing aluminum recycling process, these organic substances attached to the recycled aluminum materials can lead to the generation of organic pollutants such as dioxins during the remelting process, resulting in severe environmental pollution and public health hazards.

On the other hand, in the steel industry, to effectively remove oxygen from molten steel, improve the quality and performance of the steel, increase its purity and uniformity, reduce defects, and enhance its toughness and corrosion resistance, deoxidizing materials are extensively used in the steelmaking process. Aluminum alloys, capable of rapidly reacting with oxygen, are particularly employed as deoxidizing agents. However, aluminum alloys are costly, and the energy consumption associated with manufacturing aluminum alloy deoxidizing materials using existing technologies is very high. Therefore, there is an urgent need in the relevant field to develop an aluminum alloy deoxidizing material that can achieve a circular economy and reduce manufacturing costs.

### SUMMARY OF THE INVENTION

In order to address the issues of organic pollutants generated during the melting process of waste aluminum in existing aluminum recycling processes causing environmental pollution, as well as the high cost and energy consumption in the production process of deoxidizers required by the steelmaking industry, the present invention provides an aluminum alloy deoxidizer with carbon compounds comprises multiple aluminum pellets, wherein the aluminum pellets comprise primarily of elemental aluminum, and the aluminum pellets comprise carbon or organic compounds in a weight percentage ranging from 0.1 to 8.

Wherein, the aluminum pellets are cut from an aluminum billet, and wherein an area of a cross section of the aluminum billet ranges from 0.2 square centimeters to 450 square centimeters, and the cross section contains 20 to 500 carbon particles, wherein at least parts of the carbon particles are formed by carbonization of the organic compounds, and the carbon particles contain more than 50 weight percent carbon.

Wherein, the carbon particles comprise by weight percent 85 to 95 carbon, 2 to 8 oxygen, and 1 to 10 aluminum.

Wherein, the cross section comprises multiple grain cross sections of multiple grains, and each grain cross section is irregularly elongated, with a length of a first major axis of each grain cross section ranging from 10 micrometers to 2000 micrometers; the cross section contains 5 to 60 grain cross sections per square millimeter; and the area of each grain cross section is less than 1 square millimeter.

Wherein, the aluminum pellets are made from recycled aluminum material, and the organic compounds comprises alkanes, lipids, resins, or polyesters.

Wherein, the aluminum pellets further comprise by weight percentage 0.1 to 2 of silicon, 0 to 2 of copper, 0.1 to 30 of magnesium, 0.1 to 10 of manganese, and 0 to 10 of zinc.

Wherein, the carbon particles comprise chlorides, sulfides, nitrides, silicates, or oxides.

Wherein, the grain cross section comprises a first phase and a second phase of the grains, with a hardness ratio of the first phase to the second phase greater than 1.

Wherein, each of the aluminum pellets comprises one or more concave surfaces or hollow cavities.

Wherein, the cross section comprises 5 to 50 grain cross sections per square millimeter at or near the center of the cross section, and 10 to 60 grain cross sections per square millimeter near the periphery of the cross section.

Wherein, an area of each of the grain cross section is less than 0.6 square millimeters.

Wherein, the aluminum billet is formed by extrusion, and an extrusion direction is defined, wherein the hardness ratio between a hardness of the cross section perpendicular to the extrusion direction and a hardness of a longitudinal section parallel to the extrusion direction is greater than 1.

Wherein, the longitudinal section of the aluminum billet comprises multiple grain longitudinal sections of the grains, and each grain longitudinal section is elongated, wherein a second major axis of each grain longitudinal sections is parallel to the extrusion direction.

Wherein, the cross section and the longitudinal section of the aluminum billet comprise one or more cracks or voids.

Wherein, the aluminum billet is made of a recycled aluminum material of recycled aluminum cans, and the aluminum billet shows a preferred orientation along the (200) direction.

The present invention achieves the following benefits:
1. The production of the aluminum alloy deoxidizer with carbon compounds in the present invention does not require heating to melt scrap aluminum, thereby significantly reducing air pollution and avoiding the risk of pollutants escaping into the environment.
2. The production of the aluminum alloy deoxidizer with carbon compounds in the present invention does not require heating to melt scrap aluminum, thus saving a significant amount of energy. Additionally, it does not generate toxic fumes, dust, and slag produced during the melting of scrap aluminum.
3. The method for producing the aluminum alloy deoxidizer with carbon compounds in the present invention does not require heating to melt scrap aluminum, thereby avoiding process-related losses of metallic aluminum due to aluminum oxidation.
4. The aluminum alloy deoxidizer with carbon compounds in the present invention utilizes recycled aluminum materials as deoxidizing agents for steelmaking, thereby reducing the cost of deoxidizing agents in the steelmaking process and minimizing material losses. This approach also achieves the benefits of resource recycling and reuse.
5. The production of the aluminum alloy deoxidizer with carbon compounds in the present invention does not result in the generation of organic pollutants during the process due to the presence of organic matter in the recycled aluminum materials. This eliminates or simplifies the preprocessing steps for the recycled aluminum materials, saving time, resources, and costs. Additionally, it promotes a greener and more environmentally friendly approach.
6. The method for producing the aluminum alloy deoxidizer with carbon compounds in the present invention does not require fixing aluminum briquettes with adhesives as in prior art, thus saving costs and avoiding environmental pollution and resource waste caused by adhesives.
7. The method for producing the aluminum alloy deoxidizer with carbon compounds in the present invention involves first converting the recycled aluminum materials into aluminum billets and then cutting them into multiple aluminum pellets. Each cut surface of the pellets is a newly exposed surface with an extremely thin layer of aluminum oxide, enhancing the deoxidation effectiveness of the deoxidizer.
8. The shape of the aluminum alloy deoxidizer with carbon compounds in the present invention includes concave surfaces and hollow cavities, which increase the contact surface area and significantly enhance the deoxidation efficiency.
9. The aluminum alloy deoxidizer with carbon compounds in the present invention can further incorporate other elements. By adjusting the alloy composition, the oxidation-reduction capability and density of the aluminum pellets can be regulated, thereby enhancing the deoxidation effectiveness of the deoxidizer.
10. The method for producing the aluminum alloy deoxidizer with carbon compounds in the present invention can handle difficult-to-process aluminum waste materials, such as aluminum shavings generated from aluminum alloy machining or used aluminum cans. This addresses past challenges associated with these aluminum shavings, which have a large surface area-to-volume ratio, making them prone to oxidation. Additionally, they are often mixed with lubricants, cutting fluids, beverage residues, and coatings, making it difficult to effectively recycle and reuse them.

### BRIEF DESCRIPTION OF THE DRAWINGS

FIG. 1 is a schematic diagram of a preferred embodiment in accordance with the present invention;

FIG. 2 is a schematic diagram of an aluminum billet in a preferred embodiment in accordance with the present invention;

FIG. 3 is a schematic diagram of multiple aluminum pellets in a preferred embodiment in accordance with the present invention;

FIG. 4 is a schematic diagram of multiple aluminum pellets in a preferred embodiment in accordance with the present invention;

FIG. 5 is a schematic diagram of an aluminum billet in a preferred embodiment in accordance with the present invention, showing an extrusion direction, a cross section, and a longitudinal section;

FIG. 6 is a metallograph of a cross section of an aluminum billet in a preferred embodiment in accordance with the present invention;

FIG. 7 is a metallograph of a cross section of an aluminum billet in a preferred embodiment in accordance with the present invention;

FIG. 8 is a metallograph of a cross section of an aluminum billet in a preferred embodiment in accordance with the present invention;

FIG. 9 is a metallograph of a cross section of an aluminum billet in a preferred embodiment in accordance with the present invention;

FIG. 10 is a metallograph of a cross section of an aluminum billet in a preferred embodiment in accordance with the present invention;

FIG. 11 is a metallograph of a cross section of an aluminum billet in a preferred embodiment in accordance with the present invention;

FIG. 12 is a metallograph of a cross section of an aluminum billet in a preferred embodiment in accordance with the present invention;

FIG. 13 is a metallograph of a cross section of an aluminum billet in a preferred embodiment in accordance with the present invention;

FIG. 14 is a metallograph of a cross section of an aluminum billet in a preferred embodiment in accordance with the present invention;

FIG. 15 is a metallograph of a cross section of an aluminum billet in a preferred embodiment in accordance with the present invention;

FIG. 16 is a metallograph of a longitudinal section of an aluminum billet in a preferred embodiment in accordance with the present invention;

FIG. 17 is a metallograph of a longitudinal section of an aluminum billet in a preferred embodiment in accordance with the present invention;

FIG. 18 is a metallograph of a longitudinal section of an aluminum billet in a preferred embodiment in accordance with the present invention;

FIG. 19 is a metallograph of a longitudinal section of an aluminum billet in a preferred embodiment in accordance with the present invention;

FIG. 20 is an SEM image of a cross section of an aluminum billet in a preferred embodiment in accordance with the present invention;

FIG. 21 is an X-ray diffraction analysis diagram of an aluminum billet in a preferred embodiment in accordance with the present invention; and

FIG. 22 is an X-ray diffraction analysis diagram of an aluminum billet in a preferred embodiment in accordance with the present invention.

### DETAILED DESCRIPTION OF THE PREFERRED EMBODIMENTS

To elucidate the objectives, technical solutions, and benefits of the present invention, the following section provides some preferred embodiments in accordance with the present invention.

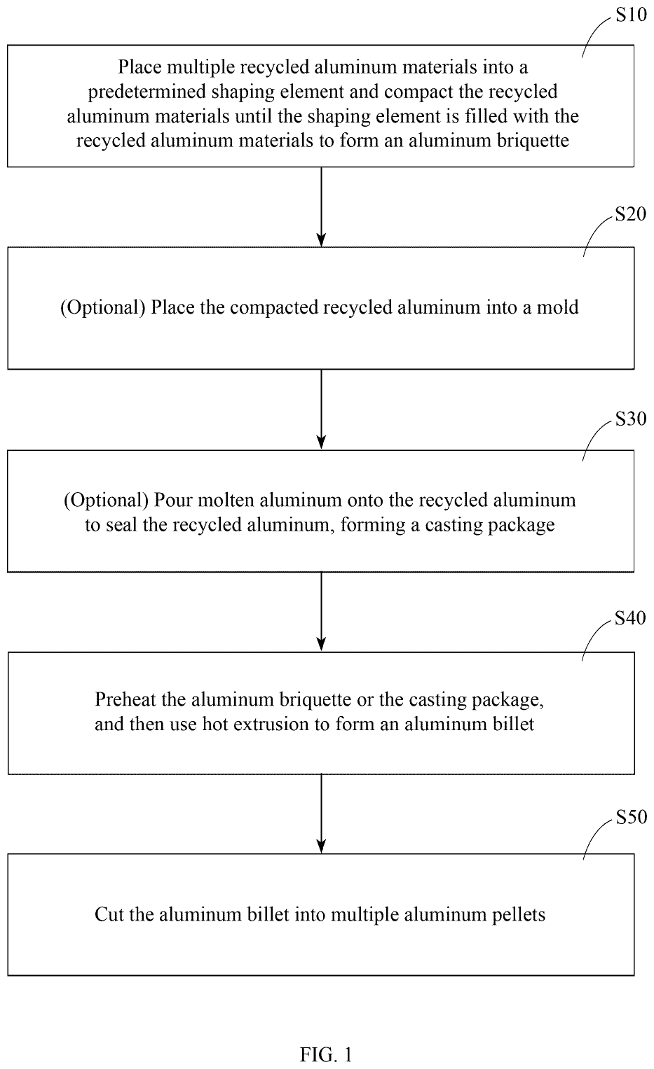

FIG. 1 illustrates the production steps of some preferred embodiments of the aluminum alloy deoxidizer with carbon compounds 1 in accordance with the present invention. The main production steps of this aluminum alloy deoxidizer involve steps S10 through S50.
Step S10: Place multiple recycled aluminum materials into a predetermined shaping element and compact the recycled aluminum materials until the shaping element is filled with the recycled aluminum materials to form an aluminum briquette. In this step S10, the collected recycled aluminum materials are collected and continuously compacted into the shaping element. As the recycled aluminum materials compress and shrink, more of the recycled aluminum materials can be added to the shaping element until the shaping element is completely filled. Preferably, the shaping element is a hollow tube, with openings at both ends or only one end. A cross-section of the hollow tube is circular. In a preferred embodiment, the circular cross-section of the hollow tube has a diameter of 9 centimeters, and the length of the hollow tube is 60 centimeters.

The recycled aluminum materials may consist of various types of aluminum waste. For instance, the recycled aluminum materials may include aluminum shavings generated during the machining process of aluminum alloy blocks, shredded recycled aluminum cans, or aluminum foil packaging. These recycled aluminum materials may originate from various sources and possess different qualities. Preferably, the recycled aluminum materials filled into the hollow tube are sourced from a single origin. The “single origin” in this specification indicates that the recycled aluminum materials originate from the same alloy series, share the same Aluminum Association alloy designation, or are derived from the production or recycling of aluminum alloy products through the same process. In one embodiment, the recycled aluminum materials originate from aluminum shavings produced during the same machining process on a single machine tool. In another embodiment, the recycled aluminum materials originate from shredded aluminum cans.

In one embodiment, the recycled aluminum materials undergo a series of preprocessing steps before being placed into the shaping element for compaction and filling. These steps may include initial cleaning and air separation to remove larger impurities, followed by magnetic separation to eliminate ferromagnetic metals. However, these preprocessing steps are not always necessary and may vary depending on the source of the recycled aluminum materials. For example, if the recycled aluminum materials originate from aluminum shavings generated during machining processes of aluminum alloy blocks, only preliminary cleaning to remove cutting fluids may be required before filling and compacting the materials into the shaping element.

Therefore, the recycled aluminum materials contain various residual organic compounds, comprising organic substances in the range of 0.1 to 8 weight percent. Preferably, the recycled aluminum materials contain organic substances in the range of 0.5 to 5 weight percent. In one embodiment, if the recycled aluminum materials originate from aluminum shavings generated during machining processes of aluminum alloy blocks, the residual organic compounds mainly consist of cutting fluids, which may include mineral oil, emulsifiers, water, rust inhibitors, defoamers, among others. In another embodiment, if the recycled aluminum materials originate from recycled aluminum cans and aluminum foil packaging, the residual organic compounds may include paper components from the aluminum foil packaging, such as cellulose, hemicellulose, or lignin, or residual printing layers and coating layers inside the aluminum cans, which may contain various lipids such as wax, various resins such as epoxy resin, or various polymers such as acrylic ester copolymers or polycarbonates. These organic substances are challenging to remove completely during preprocessing without significant time, energy, and resource consumption. However, in this step S10, the recycled aluminum materials do not require elaborate preprocessing procedures before being compacted and filled into the shaping element to form the aluminum briquette. In one embodiment, the untreated or minimally treated recycled aluminum materials are derived from Aluminum Association alloy designation 7075, containing organic substances in the range of 1.5 to 8 weight percent. In another embodiment, the untreated or minimally treated recycled aluminum materials are derived from Aluminum Association alloy designation 5000 series, containing organic substances in the range of 2 to 5 weight percent. In yet another embodiment, the untreated or minimally treated recycled aluminum materials are derived from Aluminum Association alloy designation 6000 series, containing organic substances in the range of 0.5 to 1.5 weight percent.

To enhance the effectiveness of the aluminum alloy deoxidizers with carbon compounds in accordance with the present invention, elements with strong deoxidizing effects such as magnesium, manganese, silicon, zinc, or copper may be further added to the aluminum briquette during the step of filling and compacting the encapsulating material with the recycled aluminum. This additional step aims to further improve the overall deoxidizing effect and adjust the density of the aluminum alloy deoxidizer formed by the present invention. Preferably, different proportions of these elements may be added to the aluminum briquette based on the specific composition of the recycled aluminum. In one embodiment, the aluminum briquette contains silicon ranging from 0.1 to 2 weight percent, copper ranging from 0 to 2 weight percent, magnesium ranging from 0.1 to 30 weight percent, manganese ranging from 0.1 to 10 weight percent, and zinc ranging from 0 to 10 weight percent.
Step S20 (optional): Place the compacted recycled aluminum into a mold. In this step, once the recycled aluminum has been compacted to fill the shaping element, the recycled aluminum is removed from the shaping element and placed into the desired mold. The compacted recycled aluminum can maintain its form without dispersing or deforming due to the compaction. Preferably, the shaping element is the hollow tube, and the compacted recycled aluminum, when removed, forms a cylindrical or disc shape. The mold is a long cylindrical hollow tube, with its length and cross-section larger than that of the hollow tube. At the bottom of the mold, there is a fixed ring placed at the center of a long axis, with a diameter equal to or slightly larger than the cross-section of the compacted recycled aluminum, ensuring that the compacted recycled aluminum remains centered in the mold without shifting. The mold may also include one or more tightening devices to securely hold the compacted recycled aluminum in place. In a preferred embodiment, the mold has an opening diameter of 12.7 centimeters, a length of 60 centimeters, a bottom with a fixed ring of diameter 10 centimeters and depth 1 centimeter, and the top of the mold includes an aluminum plate and a screw for tightening. In another preferred embodiment, the mold secures the compacted recycled aluminum with an aluminum alloy tube.

Additionally, in step S20, the shaping element filled with the recycled aluminum can also be directly placed into the mold without removing the recycled aluminum from the shaping element. In a preferred embodiment, the shaping element is the hollow tube, and the shaping element is made of aluminum alloy. This allows the recycled aluminum, once compacted in the hollow tube, to remain inside the tube and be placed into the mold along with the aluminum hollow tube, which serves as the tightening device. Preferably, the aluminum hollow tube has the same alloy composition as the recycled aluminum. That is, both the hollow tube and the recycled aluminum have the same alloy series or the same Aluminum Association alloy designation.
Step S30 (optional): Pour molten aluminum onto the recycled aluminum to seal the recycled aluminum, forming a casting package. In this step S30, the recycled aluminum placed in the mold is poured with molten aluminum, which completely envelops and seals the recycled aluminum. After cooling and solidification, a casting package is formed. The molten aluminum is molten aluminum alloy, and preferably, the molten aluminum has the same alloy composition as the recycled aluminum, meaning both the molten aluminum and the recycled aluminum have the same alloy series or the same Aluminum Association alloy designation. In one embodiment, the recycled aluminum obtained from a single source, such as shredded aluminum cans, is compacted and filled into the hollow tube. In this step, it is poured with molten aluminum of a similar alloy series, ensuring that the aluminum alloy in the casting package maintains uniform aluminum alloy characteristics. Preferably, the aluminum strip used for tightening also has the same alloy composition as the recycled aluminum. The molten aluminum completely seals the recycled aluminum, thus encapsulating multiple organic compounds within the casting package.

In the embodiments in accordance with this invention, either step S20 or step S30 can be chosen, or both steps can be performed.

Step S40: Preheat the aluminum briquette or the casting package, and then use hot extrusion to form an aluminum billet A. In this step S40, the aluminum billet A is formed by preheating the aluminum briquette or the casting package and subjecting it to hot extrusion. The cross-sectional shape of the aluminum billet A can be designed according to the requirements of the extrusion die through which the aluminum briquette or the casting package passes, and the hot extrusion can be direct extrusion or indirect extrusion. In particular, the indirect extrusion can generate a hollow structure inside the aluminum billet A. Preferably, the temperature of the hot extrusion is between 360° C. and 550°° C., and the extrusion speed ranges from 0.2 millimeters per second to 20 millimeters per second; the extrusion speed refers to the travel speed of the press ram of the hot extrusion machine. Additionally, the ratio of the cross-sectional area of the hollow tube to that of the aluminum billet A ranges from 40:1 to 10:1; this ratio is referred to as the extrusion ratio, and the preferred extrusion ratio in this step S40 is between 10 and 40, with a porosity of the resulting aluminum billet A being less than one percent. Furthermore, during hot extrusion, some of the organic substances in the aluminum billet A are converted into carbon. The aluminum billet A contains carbon or organic substances in a weight percentage ranging from 0.1 to 8. More preferably, the aluminum billet A contains carbon or organic substances in a weight percentage ranging from 0.5 to 5.

Preferably, step S40 can be conducted in an oxygen-free environment, such as performing extrusion in a nitrogen atmosphere, to minimize the formation of aluminum oxide inside the aluminum billet A, thereby enhancing the material properties of the aluminum billet A.

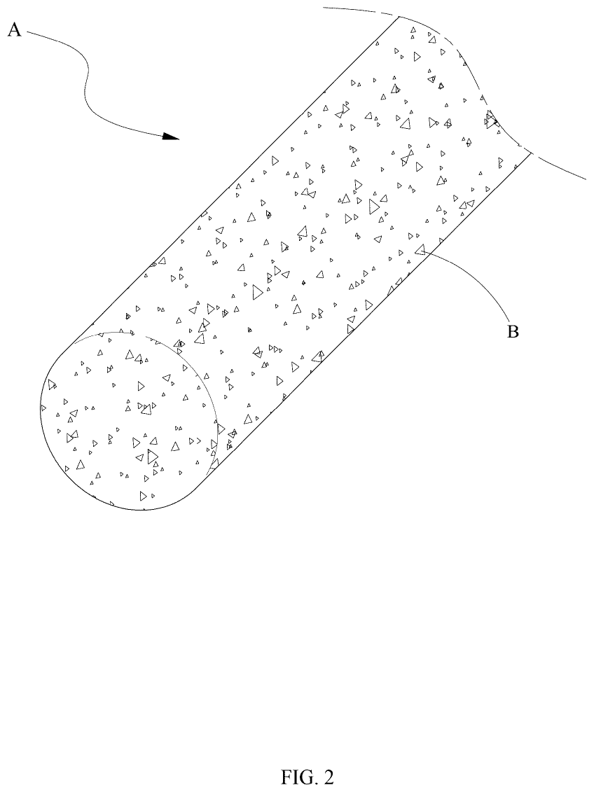

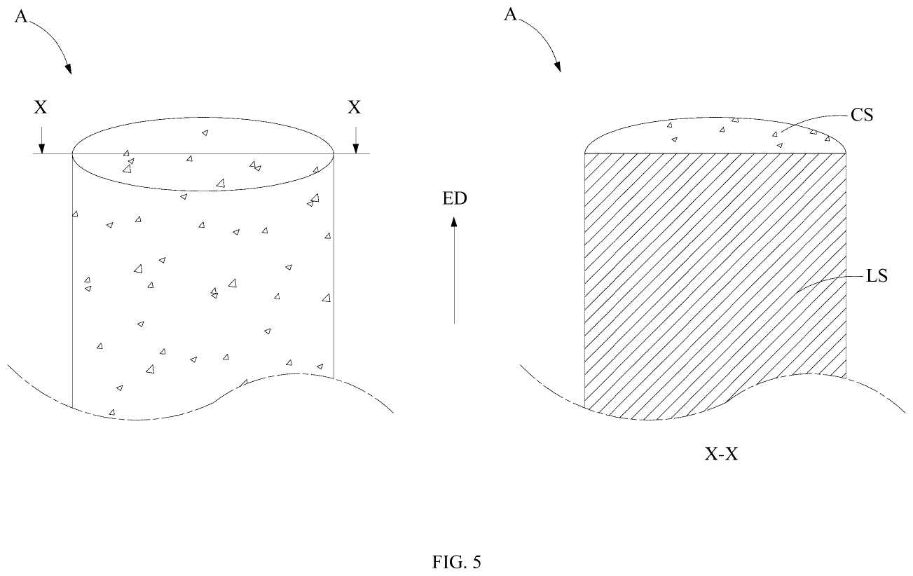

Please refer to FIG. 2 and FIG. 5. Preferably, the aluminum billet A is cylindrical, ensuring that each of multiple cross sections CS of the aluminum billet A have a same shape and area. The term “cross section” in this invention refers to the surface formed by cutting the aluminum billet A perpendicular to its extrusion direction ED. Preferably, the area of the cross section CS ranges from 0.2 square centimeters to 450 square centimeters. Furthermore, the aluminum billet A is preferably a round bar, resulting in a circular cross section CS. Preferably, the diameter of this circular cross section CS ranges from 0.5 centimeters to 2 centimeters. In one preferred embodiment in accordance with the present invention, the diameter of the circular cross section CS of the aluminum billet A is 1.4 centimeters.

Please refer to FIG. 2 through FIG. 5 and FIG. 20. When heated, the organic compounds attached to the aluminum-containing material can further carbonize, resulting in the aluminum billet A containing multiple carbon particles B. These carbon particles B consist of more than 50% carbon by weight. The carbon particles B exhibit superior high-temperature resistance, enhancing the aluminum billet A's ability to withstand high temperatures, allowing it to be processed in high-temperature environments. Additionally, the presence of these carbon particles B improves the thermal conductivity of the aluminum billet A, enabling it to exhibit excellent thermal conductivity at high temperatures. Preferably, each cross section CS of the aluminum billet A contains between 20 and 500 of these carbon particles B.

Preferably, the carbon particles B contain chlorides, sulfides, nitrides, silicates, or oxides.

Preferably, the carbon particles B comprises the following elements in the following weight percentage composition: carbon 85% to 95%, oxygen 2% to 8%, and aluminum 1% to 10%.

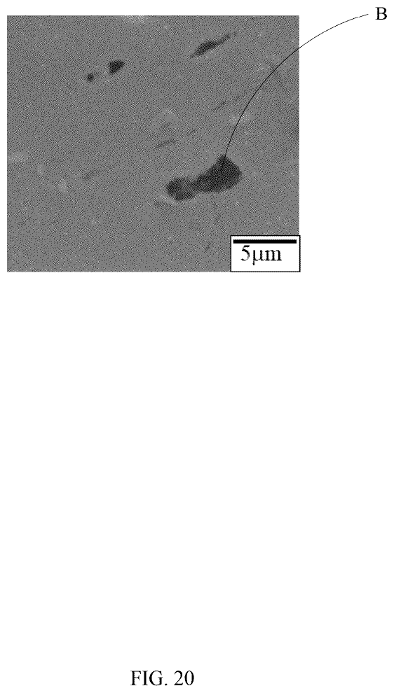

In a preferred embodiment, referring to FIG. 20, EDS analysis was conducted on the carbon particles B in the cross-sectional CS of the aluminum billet A. The carbon particles B contain the following elements with their respective weight percentages: carbon element 90.99%, oxygen element 4.22%, magnesium element 0.64%, aluminum element 2.79%, silicon element 1.16%, chlorine element 0.10%, and iron element 0.11%.

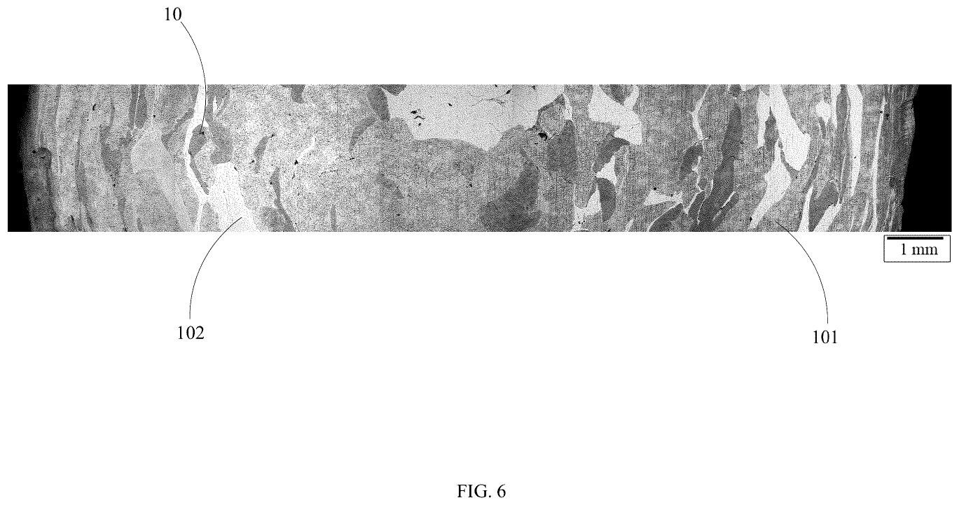

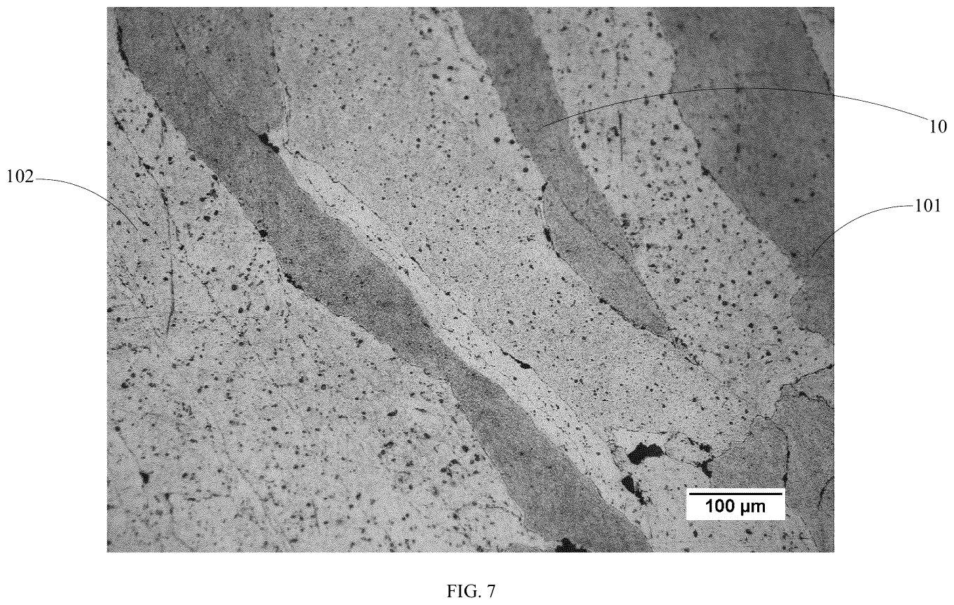

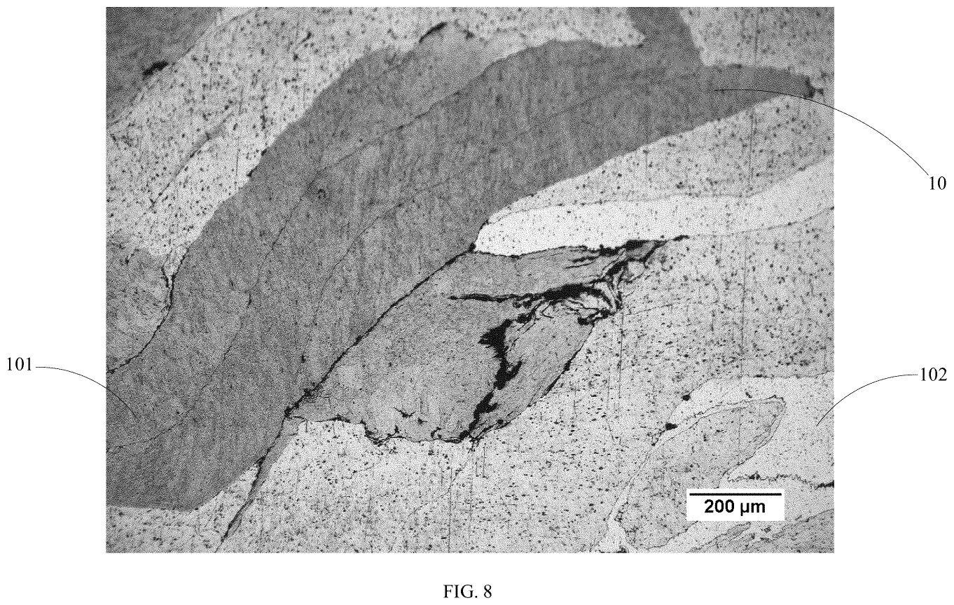

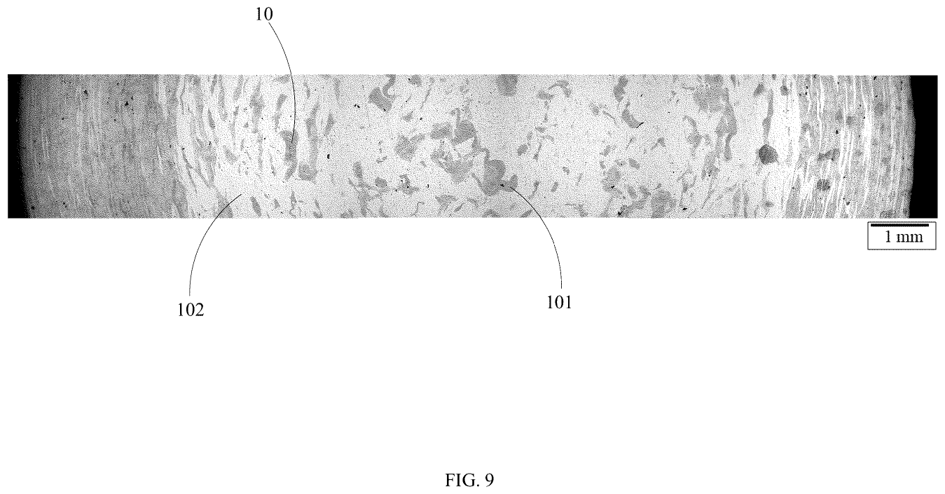

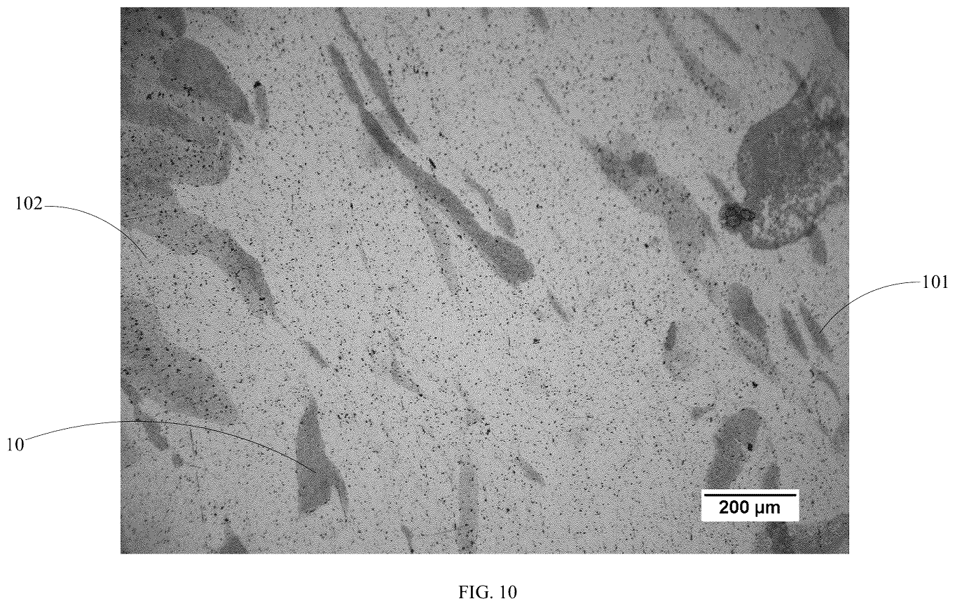

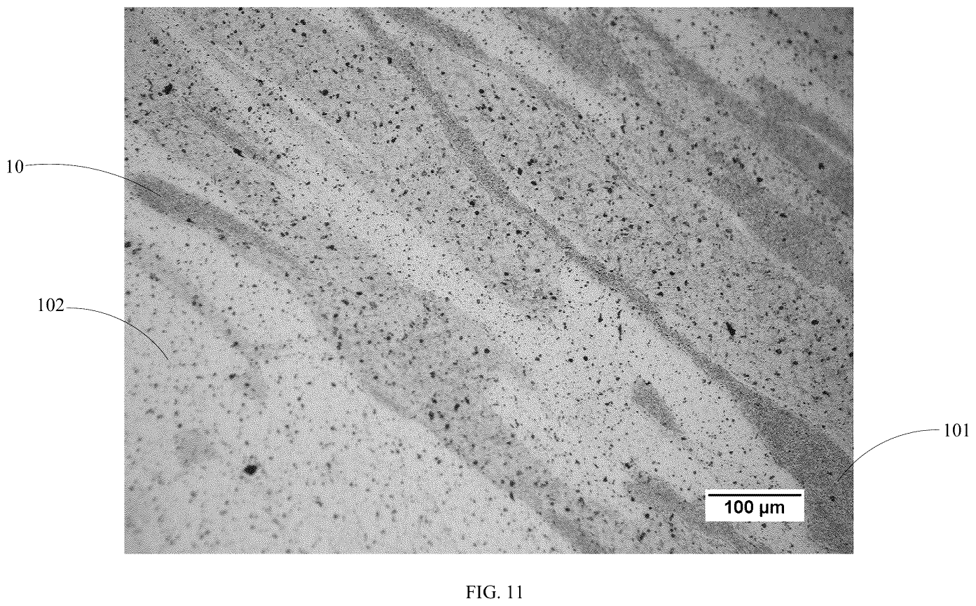

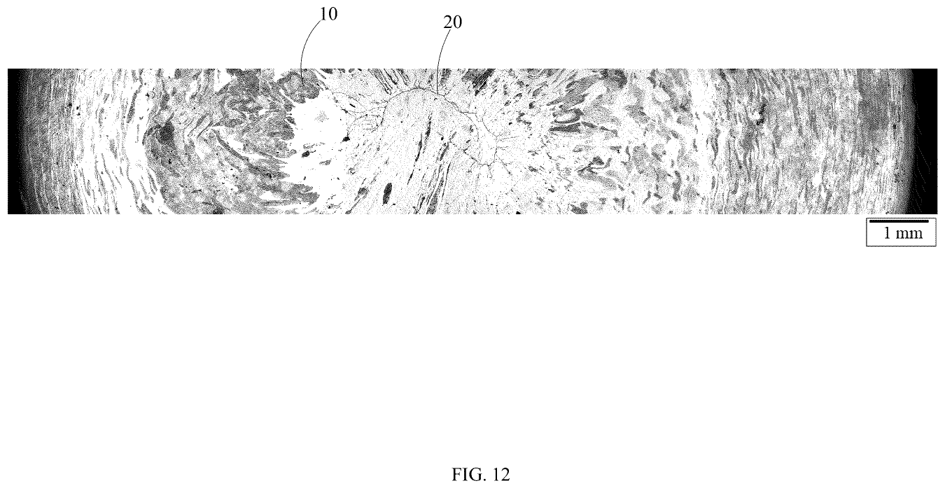

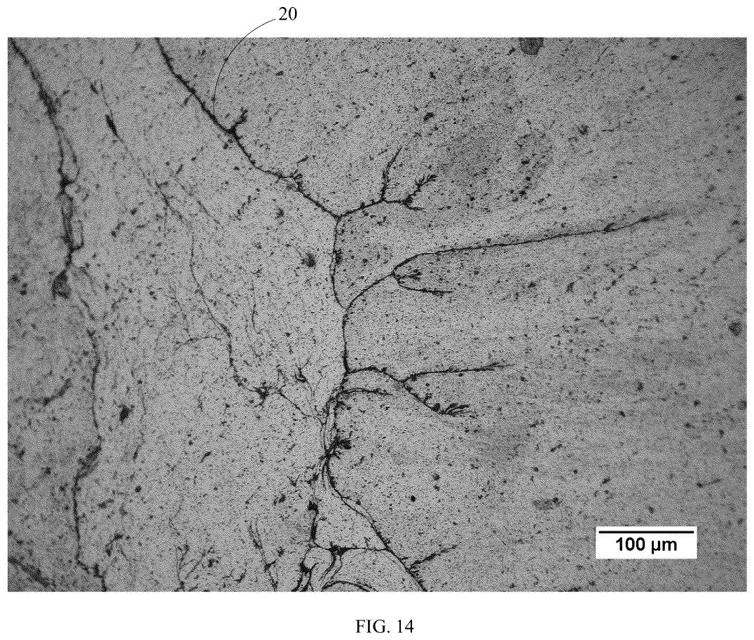

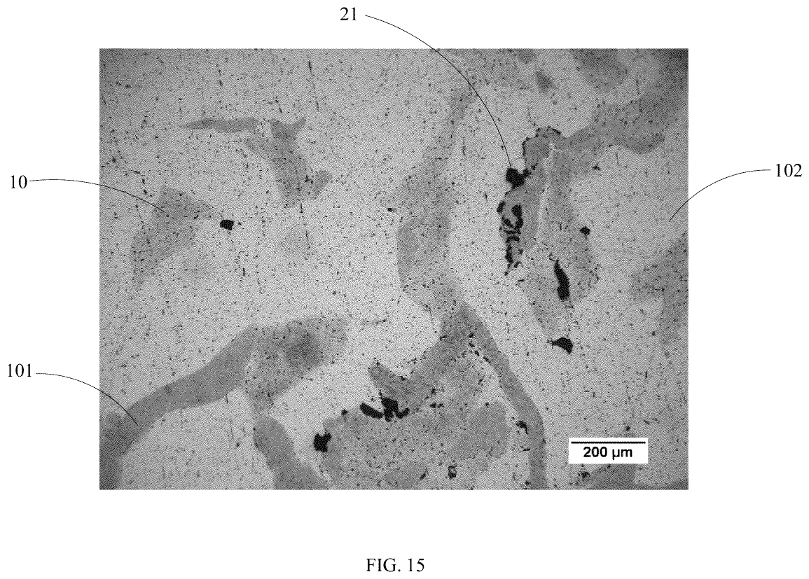

The aluminum billet A in accordance with the present invention is produced by extrusion using the recycled aluminum material without melting treatment, resulting in the unique material texture and composition of the aluminum billet A in accordance with the present invention. Please refer to FIGS. 6 to 15 for the metallographic images of multiple cross section CS of the aluminum billet A, which represent several preferred embodiments of the present invention. The metallographic images of the aluminum billet A in FIGS. 6 to 15 were prepared by making metallographic specimens from the aluminum billet A, followed by grinding with sandpapers ranging from #100 to #2000, polishing with alumina powders with particle sizes of 1 micron and 0.3 micron to achieve a mirror finish, etching with Keller's reagent after polishing, and observing and capturing the microstructure using an optical microscope.

The cross section CS of the aluminum billet A contains multiple grain cross sections 10. The cross section CS of the aluminum billet A defines a center and an outer edge. Preferably, the aluminum billet A is a circular rod, with the outer edge being circular and the center coinciding with the center of the cross section CS.

Each grain cross section 10 is irregularly elongated, preferably with at least some of the grain cross sections 10 being crescent-shaped. In the present invention, the length of the first major axis of each grain cross section 10 ranges from 10 micrometers to 2000 micrometers. The “first major axis” in this specification refers to the axis formed by the two points furthest apart within the grain cross section 10.

Each square millimeter of the cross section CS of the aluminum billet A contains 5 to 50 grain cross sections 10. Preferably, in the vicinity of the center or near the center of the cross section CS, there are 5 to 20 grain cross sections 10 per square millimeter, while near the outer edge, there are 10 to 60 grain cross sections 10 per square millimeter. In this invention, the vicinity of the center is defined as the area surrounding the center, which encloses 50% of the area of the cross section CS, while the vicinity of the outer edge is defined as the remaining grain cross sections CS outside of this area. Preferably, the area of each grain cross section 10 is less than 1 square millimeter, and preferably, the area of each grain cross section 10 is less than 0.6 square millimeters.

Please refer to FIGS. 6 to 15. During extrusion, the aluminum billet A experiences greater pressure in a radial direction at the outer edge. This results in each of the longitudinal axis of the grain cross sections 10 near the outer edge being perpendicular to the line connecting the center and a point on the outer edge.

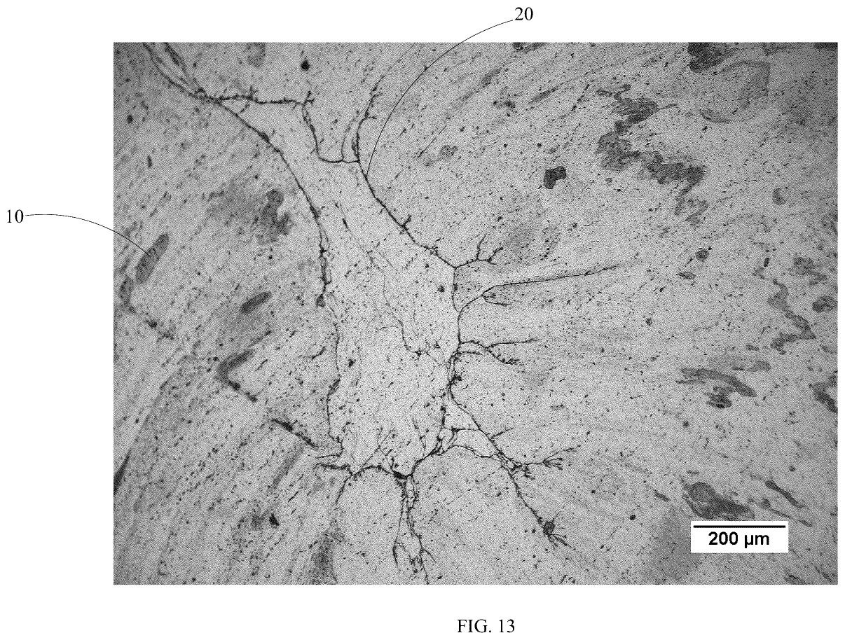

FIGS. 13 to 15 depict metallographic images of the cross section CS of a preferred embodiment of the aluminum billet A in accordance with this invention. Ideally, the cross section CS contains one or more cracks 20 or voids 21 near the center or in its vicinity. These cracks 20 or voids 21 are defects generated during the extrusion process using the recycled aluminum material containing organic substances.

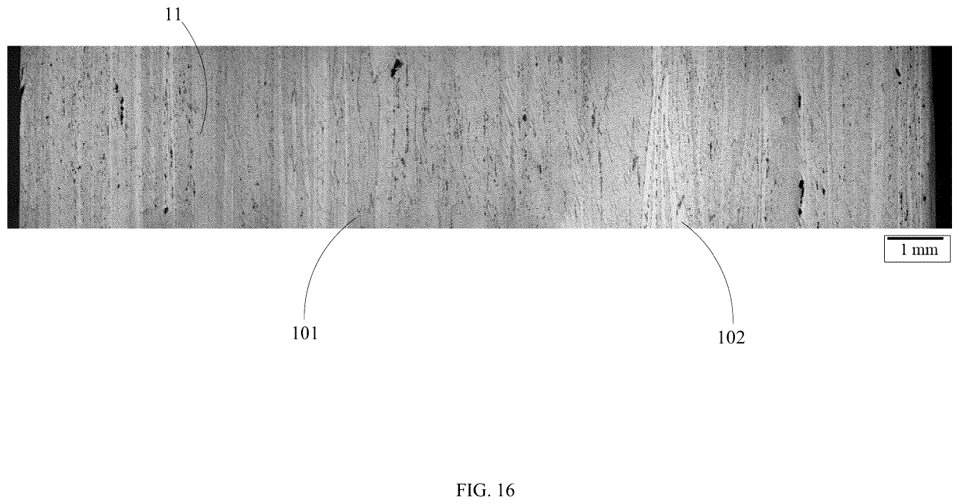

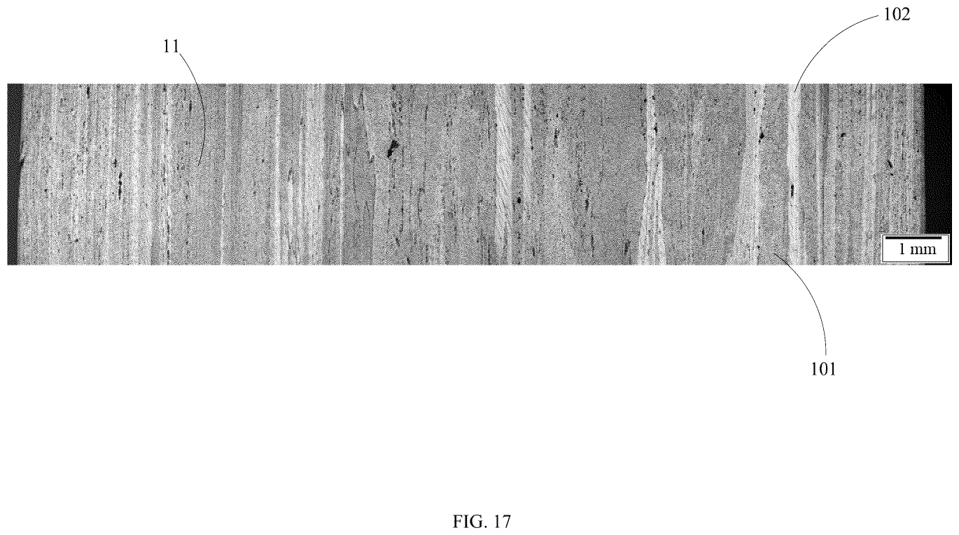

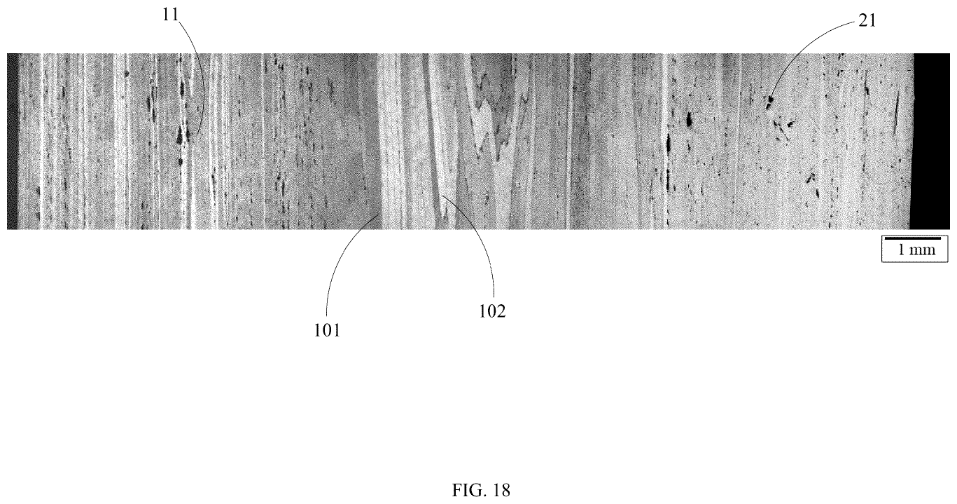

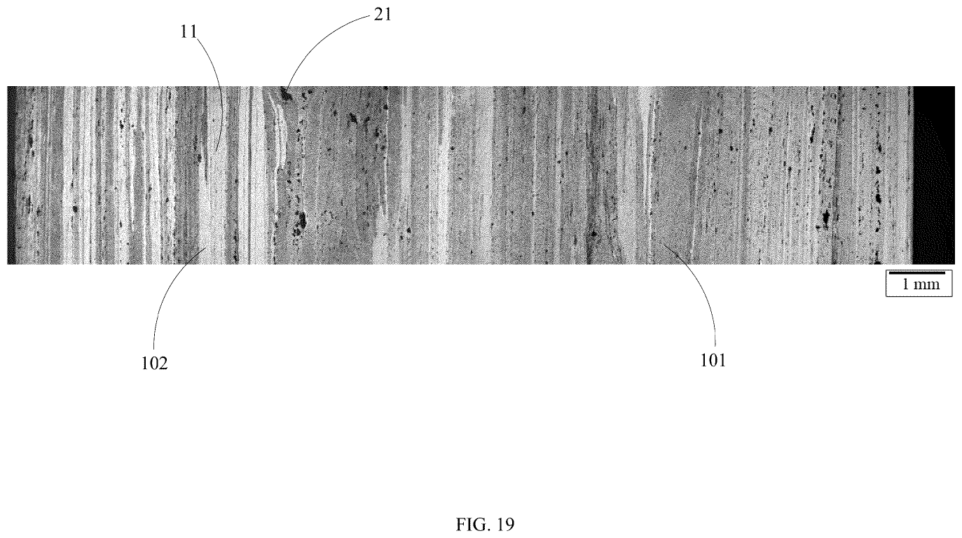

FIGS. 16 to 19 depict metallographic images of a preferred embodiment of the longitudinal section LS of the aluminum billet A in accordance with the present invention. The metallographic images of multiple longitudinal sections LS of the aluminum billet A in FIGS. 16 to 19 were obtained by preparing metallographic specimens of the aluminum billet A, embedding them in a cold-setting resin, sequentially grinding them with sandpaper ranging from #100 to #2000, polishing them to a mirror finish using polishing solutions with alumina powder particles of 1 micron and 0.3 microns in diameter, etching them with Keller's etchant, and observing and capturing the microstructure under an optical microscope.

The longitudinal section LS of the aluminum billet A contains multiple grain longitudinal sections 11 of the multiple grains. Each grain longitudinal sections 11 is elongated, and the second major axis of each grain longitudinal sections 11 is parallel to the extrusion direction ED. The “second major axis” in this specification refers to a line formed by the endpoints of the grain longitudinal sections 11 that are furthest apart in the present invention.

Preferably, the longitudinal section LS contains multiple voids 21 at boundaries of the grains, which are defects generated during the extrusion process of the recycled aluminum material.

Furthermore, the aluminum billet A exhibits anisotropic mechanical properties. The aluminum billet A is a long cylindrical shape, defining an extrusion direction ED along the direction of movement of the long cylindrical extrusion, and a radial direction perpendicular to the extrusion direction ED. In this case, the hardness of the cross section CS (i.e., the cross section CS with a normal vector parallel to the extrusion direction ED) is higher than that of the longitudinal section LS perpendicular to the radial direction. Preferably, the ratio of hardness between the cross section CS perpendicular to the extrusion direction ED and the longitudinal section LS perpendicular to the radial direction is greater than 1.2, preferably greater than 1.5. In a preferred embodiment, using the Rockwell hardness test (HRF) with a 1.588 mm diameter steel ball under a load of 60 kg, the hardness values obtained for the cross section CS ranged from 23.9 to 42.5, while the hardness values obtained for the longitudinal section LS ranged from 63.1 to 76.7.

Furthermore, as shown in FIGS. 6 to 19, the aluminum alloy rod exhibits at least two different phases of grains in both the cross section CS and the longitudinal section LS, namely a first phase 101 and a second phase 102. The first phase 101 appears darker in color in the metallographic images of both the cross section CS and the longitudinal section LS, while the second phase 102 appears lighter in color. Ideally, the first phase 101 has a higher hardness compared to the second phase 102, with a hardness ratio of the first phase 101 to the second phase 102 greater than 1.2, preferably greater than 1.5. In a preferred embodiment, measured using the Vickers hardness test, the hardness values obtained for the second phase 102 ranged from 57.1 to 64.9 HV, while those obtained for the first phase 101 ranged from 28.8 to 45.5 HV.

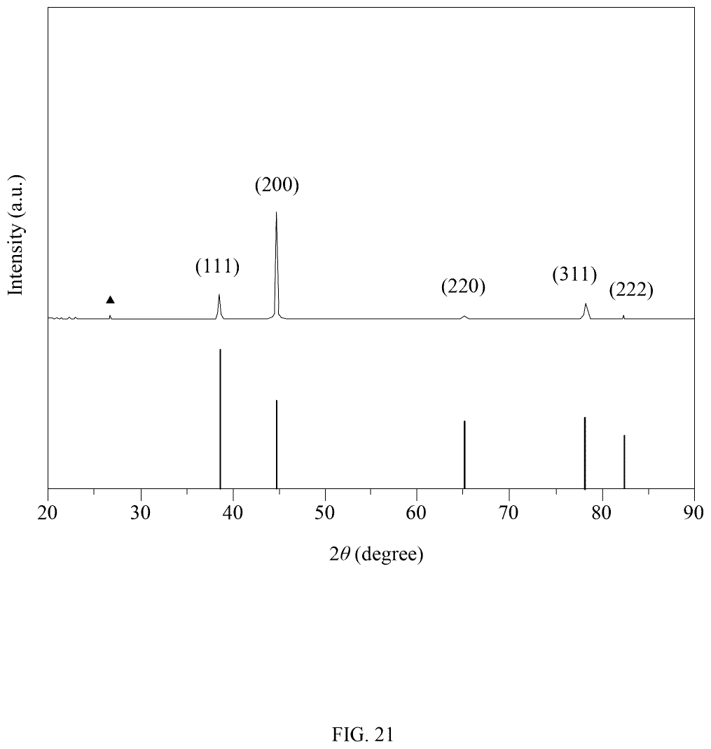

With reference to FIG. 21, X-ray diffraction analysis performed on the cross section CS perpendicular to the extrusion direction ED of the aluminum billet A reveals that the crystals within the aluminum billet A are predominantly oriented along the (200) plane, as indicated by the Miller index. This orientation differs from the random organization of crystals along the (111) plane observed in standard aluminum powder. It demonstrates a preferred orientation of crystals along the (200) direction in the aluminum billet A. Additionally, in some preferred embodiments, diffraction peaks attributed to carbon (indicated by a triangle) can be observed, indicating the presence of carbon particles B resulting from the carbonization of organic compounds within the aluminum billet A.

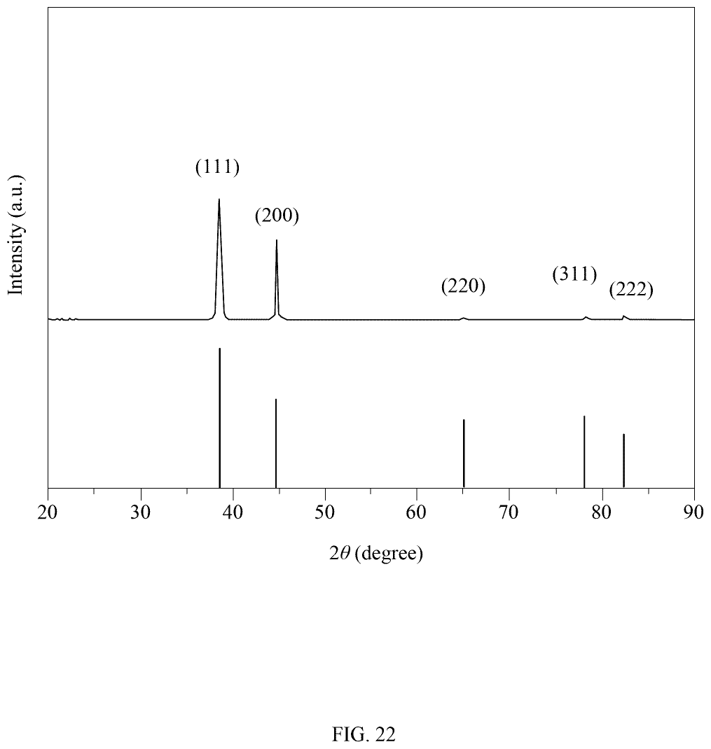

In another preferred embodiment, as depicted in FIG. 22, the recycled aluminum material comprises a mixture of aluminum alloys from the Aluminum Association's 6000 and 7000 series. X-ray diffraction analysis conducted on the longitudinal section LS parallel to the extrusion direction ED reveals that the crystals within the aluminum billet A are predominantly oriented along the (111) plane, as represented by the Miller index. This orientation is similar to the random organization of crystals along the (111) plane observed in standard aluminum powder. Additionally, there is a slight enhancement in the Miller index representation of (200) in the crystals of the aluminum billet A, indicating that in this embodiment, the aluminum billet A does not exhibit a significant preferred orientation of crystals.

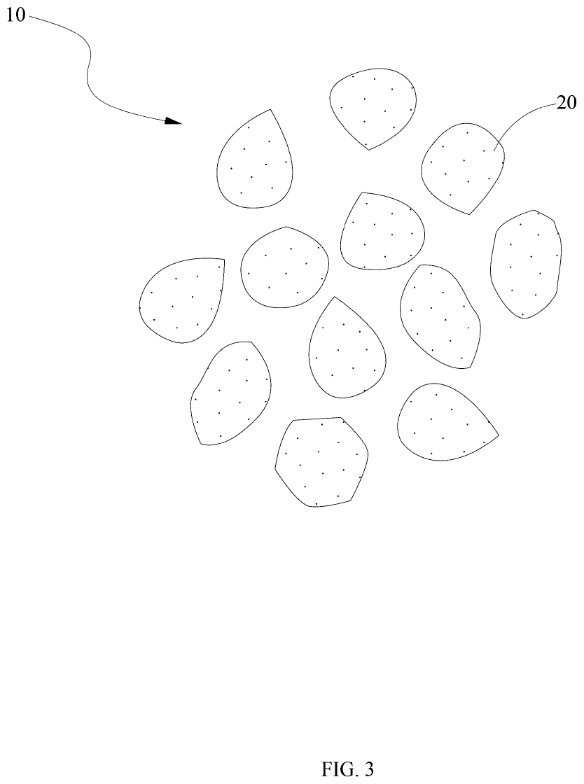

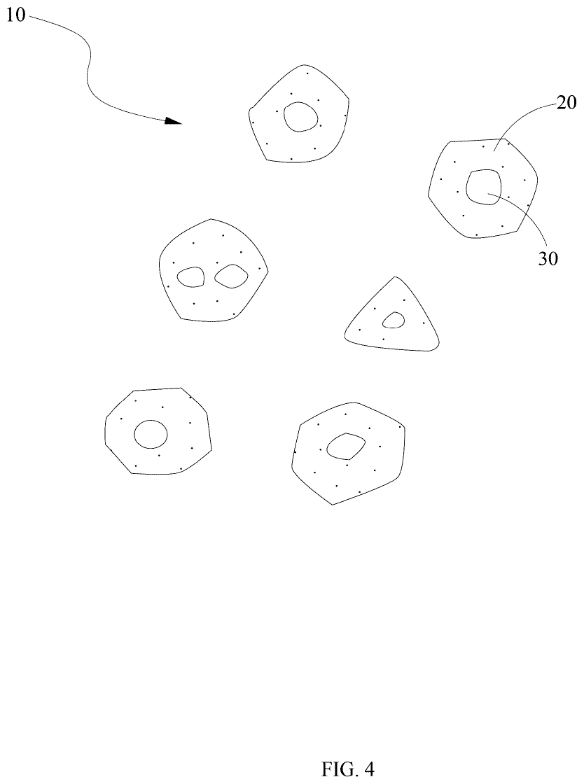

Step S50: The aluminum billet A is cut into multiple aluminum pellets 2, completing the manufacturing of the aluminum alloy deoxidizer with carbon compounds 1. Referring to FIG. 3 and FIG. 4, in this step S50, the aluminum billet A formed by hot extrusion is cut into multiple aluminum pellets 2, thereby completing the production of the aluminum alloy deoxidizer with carbon compounds 1. The aluminum pellets 2 can be spherical, droplet-shaped, or polygonal. Preferably, the aluminum alloy deoxidizer with carbon compounds 1 further includes one or more concave surfaces or hollow cavities to increase the surface area of the deoxidizer, enhancing its deoxidizing effect, and improving deoxidation efficiency. In one embodiment, in step S40, the aluminum billet A formed by indirect hot extrusion contains a hollow along the axial direction, so that when the aluminum billet is cut into multiple aluminum pellets 2, the aluminum pellets 2 formed have through holes.

Preferably, step S50 can be performed in an oxygen-free environment. For instance, the aluminum billet A can be cut into multiple aluminum pellets 2 and packaged under a nitrogen atmosphere. This reduces the likelihood of aluminum oxide forming on surfaces of the aluminum pellet 2 during cutting, thereby enhancing the deoxidation capability and efficiency of aluminum alloy deoxidizer with carbon compounds 1.

### The Properties and Applications of the Aluminum Alloy Deoxidizer With Carbon Compounds 1

Referring to FIG. 3 and FIG. 4, the aluminum alloy deoxidizer with carbon compounds 1 of the present invention is composed of multiple aluminum pellets 2, where the primary component of the aluminum pellets 2 is elemental aluminum, and the aluminum pellets 2 contains carbon or organic matter in the range of 0.1 to 8 weight percent. The term “the primary component of the aluminum pellets 2 is elemental aluminum” in the context of this invention refers to aluminum constituting the highest weight percentage compared to other components present in the aluminum pellets 2. Additionally, the aluminum comprising the aluminum pellets 2 is predominantly in elemental form rather than in the form of aluminum oxide. Upon exposure to the atmosphere, an outer layer of oxide film may form on a surface of the aluminum pellets 2, primarily composed of aluminum oxide. This oxide film densely and completely covers the aluminum pellets 2, preventing further oxidation of inorganic substances within the aluminum pellets 2, ensuring that the aluminum within the aluminum pellets 2 remains predominantly in elemental form rather than as aluminum oxide. This helps to maintain the deoxidizing effectiveness of the aluminum pellets 2. Since the aluminum pellets 2 are not produced by melting recycled aluminum materials and only have surface and internal interfaces containing oxidized inorganic substances, the deoxidizing effectiveness of the aluminum pellets 2 of the present invention is further enhanced.

Furthermore, the aluminum pellets 2 also contain silicon in the range of 0.1 to 2 weight percent, copper in the range of 0 to 2 weight percent, magnesium in the range of 0.1 to 30 weight percent, manganese in the range of 0.1 to 10 weight percent, and zinc in the range of 0 to 10 weight percent. Additionally, the carbon particles B are formed by the carbonization of organic substances such as alkanes, lipids, resins, or polyesters. In one embodiment, the organic substances primarily include cutting fluids, while in another embodiment, the organic substances mainly consist of the inner coating materials of aluminum cans. These organic substances, after undergoing the manufacturing process of the aluminum alloy deoxidizer with carbon compounds 1 of the present invention, are predominantly carbonized during preheating and hot extrusion processes and distributed in the form of carbon particles B within the aluminum pellets 2. When these aluminum pellets 2 are introduced into a steelmaking furnace, the organic substances are completely decomposed due to the furnace's temperature being much higher than the decomposition temperature of organic substances presence in the aluminum pellets 2, thereby reducing environmental pollution and toxic emissions, minimizing waste issues, and decreasing the generation of harmful organic compounds.

In one embodiment, the aluminum billet A and the aluminum pellets 2 in accordance with the present invention undergoes dioxin and furan testing. The test results for dioxin and furan are 0.013 ng I-TEQ/g and 0.00004 ng I-TEQ/g, respectively, which are significantly lower than the regulatory standards of 0.1 ng I-TEQ/g for bottom ash recycling products or soil. This confirms that the aluminum alloy deoxidizer with carbon compounds 1 of the present invention and its manufacturing process do not release dioxins due to the presence of organic substances in the recycled aluminum materials.

To optimize the deoxidation effect of the aluminum alloy deoxidizer with carbon compounds 1 of the present invention, the specific metal element ratios in the aluminum pellets 2 of the aluminum alloy deoxidizer with carbon compounds 1 can be achieved by further adjusting the metallic elements placed in the aluminum briquette or the casting package. For example, the proportion of magnesium element in the aluminum pellets 2 can be increased to enhance the deoxidation capability, or the proportion of copper element in the aluminum pellets 2 can be increased to increase the density of the aluminum pellets, thereby improving the situation where the deoxidation material floats on the surface of the molten steel and affects the deoxidation capability. In one embodiment, the aluminum pellets 2 contain by weight percentage 0.1 to 2 silicon, 0.1 to 2 magnesium, and 0.1 to 2 manganese elements. In another embodiment, the aluminum pellets 2 contain by weight percentage 0.1 to 2 silicon, 0.1 to 10 magnesium, and 0.1 to 2 manganese elements. In yet another embodiment, the aluminum pellets 2 contain by weight percentage 0.1 to 2 silicon, 1 to 2 copper, 0.1 to 1 magnesium, 0.1 to 1 manganese, and 0.1 to 10 zinc elements. In another embodiment, the aluminum pellets 2 contain by weight percentage 0.1 to 10 silicon, 0.1 to 10 magnesium, 0.1 to 2 manganese, and 0.1 to 10 zinc elements.

To enhance the effectiveness of the aluminum alloy deoxidizer with carbon compounds 1 in accordance with the present invention in achieving deoxidation, the shape of each of the aluminum pellet 2 is either spherical, droplet-shaped, or polygonal. Furthermore, to improve the deoxidation efficiency of the aluminum alloy deoxidizer with carbon compounds 1, the aluminum pellets 2 can have one or more concave surfaces or hollow cavities 3, thereby significantly increasing the surface area of the aluminum pellets 2. Deoxidizers with low porosity rates produced through hot extrusion can reduce the buoyancy of the aluminum pellets 2, thereby improving the deoxidation effect by preventing the aluminum pellets 2 from floating on the surface of the molten steel.

The aluminum alloy deoxidizer with carbon compounds 1 in accordance with the present invention provides the steel industry with a low-cost, efficient, and environmentally friendly low-carbon deoxidation material. In one embodiment, the aluminum alloy deoxidizer with carbon compounds 1 can serve as an excellent deoxidizing material for molten steel. Given that the temperature of steelmaking furnaces exceeds 1000° C., the various organic compounds remaining in the aluminum pellets 2 undergo complete carbonization and decomposition at this temperature, thus avoiding the emission of toxic organic pollutants such as dioxins associated with the aluminum alloy deoxidizer with carbon compounds 1. Additionally, the aluminum alloy deoxidizer with carbon compounds 1 effectively assists in deoxidizing the molten steel. The aluminum alloy deoxidizer with carbon compounds 1 of the present invention not only recycles conventional difficult-to-process waste aluminum materials but also converts them into value-added carbon-containing aluminum alloy deoxidizers. The conversion mitigating environmental pollution caused by harmful organic substances with low energy consumption and low metal loss.

The present invention achieves the following benefits:
1. The production of the aluminum alloy deoxidizer with carbon compounds in the present invention does not require heating to melt scrap aluminum, thereby significantly reducing air pollution and avoiding the risk of pollutants escaping into the environment.
2. The production of the aluminum alloy deoxidizer with carbon compounds in the present invention does not require heating to melt scrap aluminum, thus saving a significant amount of energy. Additionally, it does not generate toxic fumes, dust, and slag produced during the melting of scrap aluminum.
3. The method for producing the aluminum alloy deoxidizer with carbon compounds in the present invention does not require heating to melt scrap aluminum, thereby avoiding process-related losses of metallic aluminum due to aluminum oxidation.
4. The aluminum alloy deoxidizer with carbon compounds in the present invention utilizes recycled aluminum materials as deoxidizing agents for steelmaking, thereby reducing the cost of deoxidizing agents in the steelmaking process and minimizing material losses. This approach also achieves the benefits of resource recycling and reuse.
5. The production of the aluminum alloy deoxidizer with carbon compounds in the present invention does not result in the generation of organic pollutants during the process due to the presence of organic matter in the recycled aluminum materials. This eliminates or simplifies the preprocessing steps for the recycled aluminum materials, saving time, resources, and costs. Additionally, it promotes a greener and more environmentally friendly approach.
6. The method for producing the aluminum alloy deoxidizer with carbon compounds in the present invention does not require fixing aluminum briquettes with adhesives as in prior art, thus saving costs and avoiding environmental pollution and resource waste caused by adhesives.
7. The method for producing the aluminum alloy deoxidizer with carbon compounds in the present invention involves first converting the recycled aluminum materials into aluminum billets and then cutting them into multiple aluminum pellets. Each cut surface of the pellets is a newly exposed surface with an extremely thin layer of aluminum oxide, enhancing the deoxidation effectiveness of the deoxidizer.
8. The shape of the aluminum alloy deoxidizer with carbon compounds in the present invention includes concave surfaces and hollow cavities, which increase the contact surface area and significantly enhance the deoxidation efficiency.
9. The aluminum alloy deoxidizer with carbon compounds in the present invention can further incorporate other elements. By adjusting the alloy composition, the oxidation-reduction capability and density of the aluminum pellets can be regulated, thereby enhancing the deoxidation effectiveness of the deoxidizer.
10. The method for producing the aluminum alloy deoxidizer with carbon compounds in the present invention can handle difficult-to-process aluminum waste materials, such as aluminum shavings generated from aluminum alloy machining or used aluminum cans. This addresses past challenges associated with these aluminum shavings, which have a large surface area-to-volume ratio, making them prone to oxidation. Additionally, they are often mixed with lubricants, cutting fluids, beverage residues, and coatings, making it difficult to effectively recycle and reuse them.

What is claimed is:

1. An aluminum alloy deoxidizer with carbon compounds comprises multiple aluminum pellets, wherein the aluminum pellets comprise primarily of elemental aluminum, and the aluminum pellets comprise carbon or organic compounds in a weight percentage ranging from 0.1 to 8.

2. The aluminum alloy deoxidizer with carbon compounds of claim 1, wherein the aluminum pellets are cut from an aluminum billet, and wherein an area of a cross section of the aluminum billet ranges from 0.2 square centimeters to 450 square centimeters, and the cross section contains 20 to 500 carbon particles, wherein at least parts of the carbon particles are formed by carbonization of the organic compounds, and the carbon particles contain more than 50 weight percent carbon.

3. The aluminum alloy deoxidizer with carbon compounds of claim 2, wherein the carbon particles comprise by weight percent 85 to 95 carbon, 2 to 8 oxygen, and 1 to 10 aluminum.

4. The aluminum alloy deoxidizer with carbon compounds of claim 2, wherein the cross section comprises multiple grain cross sections of multiple grains, and each grain cross section is irregularly elongated, with a length of a first major axis of each grain cross section ranging from 10 micrometers to 2000 micrometers;
the cross section contains 5 to 60 grain cross sections per square millimeter; and
the area of each grain cross section is less than 1 square millimeter.

5. The aluminum alloy deoxidizer with carbon compounds of claim 2, wherein the aluminum pellets are made from recycled aluminum material, and the organic compounds comprises alkanes, lipids, resins, or polyesters.

6. The aluminum alloy deoxidizer with carbon compounds of claim 5, wherein the aluminum pellets further comprise by weight percentage 0.1 to 2 of silicon, 0 to 2 of copper, 0.1 to 30 of magnesium, 0.1 to 10 of manganese, and 0 to 10 of zinc.

7. The aluminum alloy deoxidizer with carbon compounds of claim 2, wherein the carbon particles comprise chlorides, sulfides, nitrides, silicates, or oxides.

8. The aluminum alloy deoxidizer with carbon compounds of claim 4, wherein the grain cross section comprises a first phase and a second phase of the grains, with a hardness ratio of the first phase to the second phase greater than 1.

9. The aluminum alloy deoxidizer with carbon compounds of claim 2, wherein each of the aluminum pellets comprises one or more concave surfaces or hollow cavities.

10. The aluminum alloy deoxidizer with carbon compounds of claim 2, wherein the cross section comprises 5 to 50 grain cross sections per square millimeter at or near the center of the cross section, and 10 to 60 grain cross sections per square millimeter near the periphery of the cross section.

11. The aluminum alloy deoxidizer with carbon compounds of claim 2, wherein an area of each of the grain cross section is less than 0.6 square millimeters.

12. The aluminum alloy deoxidizer with carbon compounds of claim 2, wherein the aluminum billet is formed by extrusion, and an extrusion direction is defined, wherein the hardness ratio between a hardness of the cross section perpendicular to the extrusion direction and a hardness of a longitudinal section parallel to the extrusion direction is greater than 1.

13. The aluminum alloy deoxidizer with carbon compounds of claim 8, wherein the aluminum billet is formed by extrusion, and an extrusion direction is defined, wherein the hardness ratio between a hardness of the cross section perpendicular to the extrusion direction and a hardness of a longitudinal section parallel to the extrusion direction is greater than 1.

14. The aluminum alloy deoxidizer with carbon compounds of claim 12, wherein the longitudinal section of the aluminum billet comprises multiple grain longitudinal sections of the grains, and each grain longitudinal section is elongated, wherein a second major axis of each grain longitudinal sections is parallel to the extrusion direction.

15. The aluminum alloy deoxidizer with carbon compounds of claim 13, wherein the longitudinal section of the aluminum billet comprises multiple grain longitudinal sections of the grains, and each grain longitudinal section is elongated, wherein a second major axis of each grain longitudinal sections is parallel to the extrusion direction.

16. The aluminum alloy deoxidizer with carbon compounds of claim 12, wherein the cross section and the longitudinal section of the aluminum billet comprise one or more cracks or voids.

17. The aluminum alloy deoxidizer with carbon compounds of claim 15, wherein the cross section and the longitudinal section of the aluminum billet comprise one or more cracks or voids.

18. The aluminum alloy deoxidizer with carbon compounds of claim 2, wherein the aluminum billet is made of a recycled aluminum material of recycled aluminum cans, and the aluminum billet shows a preferred orientation along the (200) direction.

19. The aluminum alloy deoxidizer with carbon compounds of claim 5, wherein the aluminum billet is made of a recycled aluminum material of recycled aluminum cans, and the aluminum billet shows a preferred orientation along the (200) direction.

20. The aluminum alloy deoxidizer with carbon compounds of claim 13, wherein the aluminum billet is made of a recycled aluminum material of recycled aluminum cans, and the aluminum billet shows a preferred orientation along the (200) direction.
